(19) United States
(12) Patent Application Publication
(10) Pub. No.: US 2025/0328968 A1
(43) Pub. Date: Oct. 23, 2025

(54) CONSENT-BASED MATCHING AND SOCIAL INTERACTION METHODS

(71) Applicant: Suely Brandes, Juno Beach, FL (US)

(72) Inventor: Suely Brandes, Juno Beach, FL (US)

(21) Appl. No.: 19/185,568

(22) Filed: Apr. 22, 2025

Related U.S. Application Data
(60) Provisional application No. 63/637,767, filed on Apr. 23, 2024.

(51) Int. Cl. G06Q 50/00

(52) U.S. Cl. CPC G06Q 50/01

(57) ABSTRACT

Systems and methods for providing a consent-based matching and social interactions is disclosed. A user input from each of a plurality of user devices associated with a plurality of users of a digital platform is received. A compatibility score for the plurality of users based on analysis of the user input of each of the plurality of users is determined. A consent verification for social parameters of each of the plurality of users based on the analysis of the user input is initiated. A match between one or more users of the plurality of users based on the compatibility score and the consent verification is identified. A notification to the matched one or more users is transmitted, the notification enabling the matched one or more users to securely communicate with each other.

### CROSS-REFERENCE TO RELATED APPLICATIONS

This application claims the benefit of U.S. Provisional Patent Application 63/637,767, filed on Apr. 23, 2024, which is incorporated by reference herein in its entirety.

### FIELD OF THE INVENTION

The present invention relates generally to applications, and more particularly, to computer-implemented social networking systems and methods, with a focus on facilitating inter-personal connections through digital platforms.

### BACKGROUND OF THE INVENTION

The evolution of social networking platforms and online dating applications has significantly changed the landscape of human connections in the digital age. These platforms have provided new avenues for individuals to meet, interact, and form relationships, whether platonic or romantic. However, the rapid growth of these services has also introduced challenges, including issues related to privacy, safety, and the quality of connections formed. Moreover, the emphasis on quick, often appearance-based judgements and superficial interactions has left a gap for those seeking more meaningful and genuine connections, particularly among older adults or those experiencing significant life transitions.

This demographic often finds traditional dating platforms intimidating or misaligned with their desire for companionship rather than romantic entanglement. This can lead to discomfort and negative experiences, especially for individuals sensitive to physical boundaries. Additionally, the mental health implications of loneliness and isolation, increased by the digital divide, have become increasingly apparent.

None of the traditional platforms specifically address the nuanced needs of individuals seeking companionship with the foundational element of consent-based connection. The traditional platforms do not adequately support the establishment of relationships where physical contact is not primarily romantic. Building trust between users is crucial for any platform facilitating connections. Existing platforms often lack the features and mechanisms necessary to create a sense of trust and safety, which are critical for encouraging users to engage in more meaningful interactions.

Therefore, there is a well-established need for a platform that bridges the gap, providing a safe, respectful, and consent-focused environment for individuals to connect and form meaningful connections.

### SUMMARY OF THE INVENTION

In an aspect, the present disclosure relates to a computer-implemented method including receiving, by a connection engine associated with a digital platform, a user input from each of a plurality of user devices associated with a plurality of users of the digital platform, wherein the user input comprises profile information associated with the plurality of users, determining, by the connection engine, a compatibility score for the plurality of users based on analysis of the profile information of each of the plurality of users, initiating, by the connection engine, consent verification for one or more social parameters of each of the plurality of users based on the analysis of the profile information, identifying, by the connection engine, a match between one or more users of the plurality of users based on the compatibility score and the consent verification, and transmitting, by the connection engine, a notification to the matched one or more users, the notification enabling the matched one or more users to securely communicate with each other.

In an aspect, the profile information may include at least one of interests, hobbies, personal values, lifestyle choices, relationship goals, and personal boundaries.

In an aspect, the method may include updating, by the connection engine, the compatibility score based on feedback from the matched one or more users.

In an aspect, determining, by the connection engine, the compatibility score may include determining the compatibility score via a machine learning algorithm trained on historical data and user interaction outcomes.

In an aspect, wherein the consent verification may include validating, by the connection engine, user preferences regarding physical contact including one or more of hand holding, walking, and personal space.

In an aspect, initiating the consent verification may comprise rendering, by the connection engine, a user interface on the user device for the user to provide information corresponding to the one or more social parameters, the information being indicative of social boundaries that the user would like to set for a first meeting with a matched user.

In another aspect, the present disclosure relates to a connection engine associated with a digital platform, wherein the connection engine may include a memory to store instructions, and a processor in communication with the memory. The processor may be configured to execute the instructions to receive a user input from each of a plurality of user devices associated with a plurality of users of the digital platform, wherein the user input comprises profile information associated with the plurality of users, determine a compatibility score for the plurality of users based on analysis of the profile information of each of the plurality of users, initiate a consent verification for one or more social parameters of each of the plurality of users based on the analysis of the profile information, identify a match between one or more users of the plurality of users based on the compatibility score and the consent verification, and transmit a notification to the matched one or more users, the notification enabling the matched one or more users to securely communicate with each other.

In another aspect, the present disclosure relates to a non-transitory computer-readable storage medium comprising instructions executable by a processor, the instructions to cause the processor to carry out any of the methods disclosed herein.

These and other objects, features, and advantages of the present disclosure will become more readily apparent from the attached drawings and the detailed description of the preferred embodiments, which follow.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 shows an example networked environment with which or in which embodiments of the present disclosure may be implemented;

FIG. 2 shows an example representation of a graphical user interface associated with a digital platform, in accordance with some embodiments of the present disclosure;

FIG. 3A shows an example representation of a graphical user interface associated with a digital platform for entering profile information, in accordance with some embodiments of the present disclosure;

FIG. 3B shows an example representation of a graphical user interface associated with a digital platform for setting one or more social parameters, in accordance with some embodiments of the present disclosure;

FIG. 4 shows a flow chart of an example method for providing a connection matching application, in accordance with some embodiments of the disclosure; and

FIG. 5 shows an exemplary computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

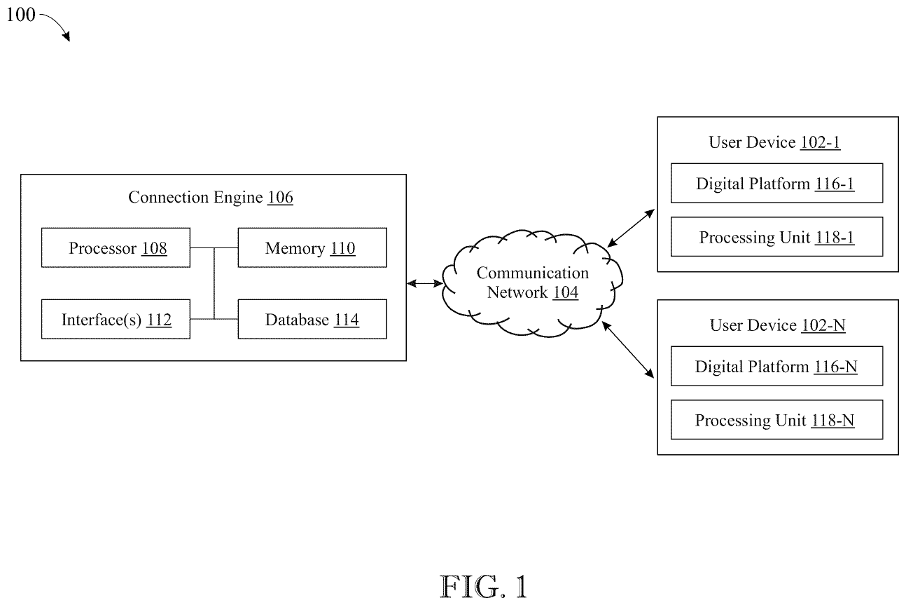

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description, certain specific details are set forth in order to provide a thorough understanding of various disclosed implementations. However, one skilled in the relevant art will recognize that implementations may be practiced without one or more of these specific details, or with other methods, components, materials, and the like.

Unless the context requires otherwise, throughout the specification and claims which follow, the word “comprise” and variations thereof, such as, “comprises” and “comprising” are to be construed in an open, inclusive sense that is as “including, but not limited to.”

As used in this specification and the appended claims, the singular forms “a,” “an,” and “the” include plural referents unless the content clearly dictates otherwise. It should also be noted that the term “or” is generally employed in its broadest sense that is as meaning “and/or” unless the content clearly dictates otherwise.

The headings and Abstract of the Disclosure provided herein are for convenience only and do not interpret the scope or meaning of the implementations.

Shown throughout the figures, the present disclosure is directed to computer-implemented social networking systems and methods, with a focus on facilitating inter-personal connections through digital platforms.

The various embodiments throughout the disclosure will be explained in more detail with reference to FIGS. 1-5.

FIG. 1 shows an exemplary networked environment 100, in accordance with some embodiments of the present disclosure.

With reference to FIG. 1, the networked environment 100 may include a connection engine 106 that may host a connection matching application. The networked environment 100 may further include a plurality of user devices (102-1 . . . 102-N) associated with a plurality of users (not shown). It may be appreciated that the user devices (102-1 . . . 102-N) may be individually referred as the user device 102 and collectively referred as the user devices 102. A person of ordinary skill in the art will understand that there may be any number of user devices 102 within the scope of the present disclosure.

In some embodiments, each user device 102 comprises a digital platform (116-1 . . . 116-N) communicatively coupled with the connection engine 106. In some embodiments, the digital platform (116-1 . . . 116-N) may be a mobile application (“app”). The mobile application may be installed on the user device 102. In some embodiments, the digital platform (116-1 . . . 116-N) may be a web application (e.g., a website or a webpage). In some embodiments, the digital platform (116-1 . . . 116-N) may be a desktop application. The digital platform (116-1 . . . 116-N) in conjunction with a processing unit (118-1 . . . 118-N) may render a graphical user interface on the user device 102 such that a user of the user device 102 may communicate with the connection engine 106 via the graphical user interface rendered on the user device 102. The graphical user interface may be rendered on the user device 102 under control of the connection engine 106. In some embodiments, the digital platform (116-1 . . . 116-N) may be hosted on the connection engine 106.

Referring to FIG. 1, the connection engine 106 may be communicatively coupled to the plurality of user devices 102 via a communication network 104. In some embodiments, the connection engine 106 may include suitable logic, circuitry, interfaces, and/or code that may be configured to receive a user input from each of the plurality of user devices 102 associated with the plurality of users of the connection matching sharing application. The user input may include profile information to help the connection engine 106 and other users understand each user's characteristics, preferences, interests, and what they are seeking from the connection matching application. In some embodiments, the profile information may include, but not limited to, basic personal information such as name, age, gender, location, and other demographic details, interests and hobbies, photographs, biographical and background information such as educational background, work history, family life, or any other aspects of their personal history that wish to share, personality descriptions, preferences and desires for connections, mental well-being goals, communication preferences, and safety and privacy settings. It may be appreciated that profile information include additional information within the scope of the present disclosure.

Referring to FIG. 1, examples of the connection engine 106 may include, but are not limited to, a computer workstation, a mainframe computer, a handheld computer, a cellular/mobile phone, and other computing devices. In some embodiments, the connection engine 106 may be implemented as a cloud server which may execute operations through web applications, cloud applications, Hypertext Transfer Protocol (HTTP) requests, repository operations, file transfer, and the like. Other examples of the connection engine 106 may include, but are not limited to, a database server, a file server, a web server, a media server, an application server, a mainframe server, a cloud server, or other types of servers. In some embodiments, the connection engine 106 may be implemented as a plurality of distributed cloud-based resources by use of several technologies that are well known to those skilled in the art.

In some embodiments, each of the plurality of user devices 102 may include suitable logic, circuitry, interfaces, and/or code that may be configured to receive the user input from the corresponding user. Specifically, each of the plurality of user devices 102 may be configured to receive the user input from the corresponding user and transmit the received user input to the connection engine 106.

Examples of the each of the plurality of user devices 102 may include, but are not limited to, a telephone, a smartphone, a cellular phone, a mobile phone, a personal digital assistant (PDA) device, a tablet, a gaming device, a computing device, an imaging device, a mainframe machine, a server, a computer workstation, and the like. In some embodiments, the plurality of user devices 102 may include, but is not limited to, any electrical, electronic, electro-mechanical, or an equipment, or a combination of one or more of the above devices such as virtual reality (VR) devices, augmented reality (AR) devices, a general-purpose computer, desktop, personal digital assistant, mainframe computer, or any other computing device, wherein the plurality of user devices 102 may include one or more in-built or externally coupled accessories including, but not limited to, a visual aid device such as camera, audio aid, a microphone, a keyboard, and input devices for receiving input from the corresponding user such as touch pad, touch enabled screen, electronic pen, and the like.

A person of ordinary skill in the art will appreciate that the plurality of user devices 102 may not be restricted to the mentioned devices and various other devices may be used.

In some embodiments, each user device of the plurality of user devices 102 may include a display device. The display device may include suitable logic, circuitry, and interfaces that may be configured to display the user input(s), confirmation message, user information, or the like. The display device may be further configured to display a set of user interface (UI) elements to receive the first user input and the second user input. The display device may be a touch screen which may enable the corresponding user to provide the user input via the display device. The touch screen may include, but not be limited to, a resistive touch screen, a capacitive touch screen, or a thermal touch screen. The display device may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with some embodiments, the display device may refer to a display screen of a head mounted device (HMD), a smart-glass device, a see-through display, a projection-based display, an electro-chromic display, or a transparent display.

Referring to FIG. 1, the communication network 104 may include a communication medium through which the connection engine 106 and the plurality of user devices 102 may communicate with each other. The communication network 104 may be a wired or wireless communication network. Examples of the communication network 104 may include, but are not limited to, the Internet, a cloud network, a Wireless Fidelity (Wi-Fi) network, a Personal Area Network (PAN), a Local Area Network (LAN), or a Metropolitan Area Network (MAN).

Various devices in the networked environment 100 may be configured to connect to the communication network 104, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), HTTP, File Transfer Protocol (FTP), wireless access point (AP), device to device communication, cellular communication protocols, and Bluetooth (BT) communication protocols, or the like.

In operation, the connection engine 106 may be configured to analyze the profile information of the plurality of users. Advanced natural language processing (NLP) techniques may be used by the connection engine 106 to extract meaningful insights from the profile information such as understanding preferences and personality descriptions. In some embodiments, key compatibility factors may be identified from the profile information by the connection engine 106 which may be critical in determining the potential for a meaningful connection. The key compatibility factors may include, but not limited to, shared interests, similar or complementary personality traits, mutual consent preferences, and alignment in communication styles and mental well-being objectives. For example, two users who both prioritize mental well-being and seek platonic companionship for outdoor activities may be identified as having a high potential for a compatible match. In some embodiments, certain aspects of the profile information may be given more weight than other aspects based on the user's indicated preferences. The connection engine 106 may allow the users to adjust the weighting of the aspects of the profile information.

In some embodiments, a scoring algorithm may be used by the connection engine 106 to determine a compatibility score for each of the plurality of users. The compatibility score may be based on weighted compatibility factors to evaluate the degree of match between the users. Various computational models, including machine learning (ML) techniques, may be used to predict compatibility potential based on the comprehensive analysis of the profile information. The compatibility score is a quantified representation of the potential for a meaningful and satisfying connection between two users, with higher scores indicating a higher likelihood of compatibility.

In some embodiments, a consent verification for one or more social parameters of the plurality of users may be initiated by the connection engine 106 based on analysis of the profile information. The one or more social parameters may include, but not limited to, physical contact (e.g., hand holding), meeting settings, and communication preferences. Based on the compatibility score and the consent verification, the connection engine 106 may identify a match between one or more users. The connection engine 106 may generate a notification for the matched users. In some embodiments, the notification may include information about the match and emphasize on the mutual compatibility and consent that underpin the connection. The notification may also guide users on possible next steps, such as arranging a meeting in a safe, public place or continuing to communicate online to build trust.

Referring to FIG. 1, the connection engine 106 may include a processor 108, a memory 110, interface(s) 112, and a database 114. In some embodiments, the processor 108 may include suitable logic, circuitry, and interfaces that may be configured to execute program instructions associated with different operations to be executed by the connection engine 106. For example, some of the operations may include, but are not limited to, receiving the user input, determining the compatibility score, initiating the consent verification, identifying the match, and outputting the notification. In some embodiments, the processor 108 may execute an application such as the connection matching application (for example, as a mobile application or website application).

In some embodiments, the one or more processor(s) 108 may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) 108 may be configured to fetch and execute computer-readable instructions stored in the memory 110 of the connection engine 106. The memory 110 may be configured to store one or more computer-readable instructions or routines in a non-transitory computer readable storage medium, which may be fetched and executed to create or share data packets over a network service. The memory 110 may comprise any non-transitory storage device including, for example, volatile memory such as Random-Access Memory (RAM), or non-volatile memory such as Electrically Erasable Programmable Read-only Memory (EPROM), flash memory, and the like.

In some embodiments, the connection engine 106 may include the interface(s) 112. The interface(s) 112 may comprise a variety of interfaces, for example, interfaces for data input and output devices, referred to as input/output (I/O) devices, storage devices, and the like. The interface(s) 112 may facilitate communication for the connection engine 106. The interface(s) 112 may also provide a communication pathway for one or more components of the connection engine 106. Examples of such components include, but are not limited to, the database 114. In some embodiments, the database 114 may comprise data that may be either stored or generated as a result of functionalities implemented by any of the components of the processor 108. The database 114 may store the user input. In some embodiments, the database 114 may store profiles associated with each of the plurality of users.

In some embodiments, the interface(s) 112 may include suitable logic, circuitry, and interfaces that may be configured to facilitate a communication between the processor 108 and the plurality of user devices 102 via the communication network 104. The interface(s) 112 may be implemented by use of various known technologies to support wired or wireless communication of the connection engine 106 with the communication network 104. The interface 112 may include, for example, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

Although FIG. 1 shows exemplary components of the networked environment 100, in other embodiments, the networked environment 100 may include fewer components, different components, differently arranged components, or additional functional components than depicted in FIG. 1. Additionally, or alternatively, one or more components of the networked environment 100 may perform functions described as being performed by one or more other components of the networked environment 100.

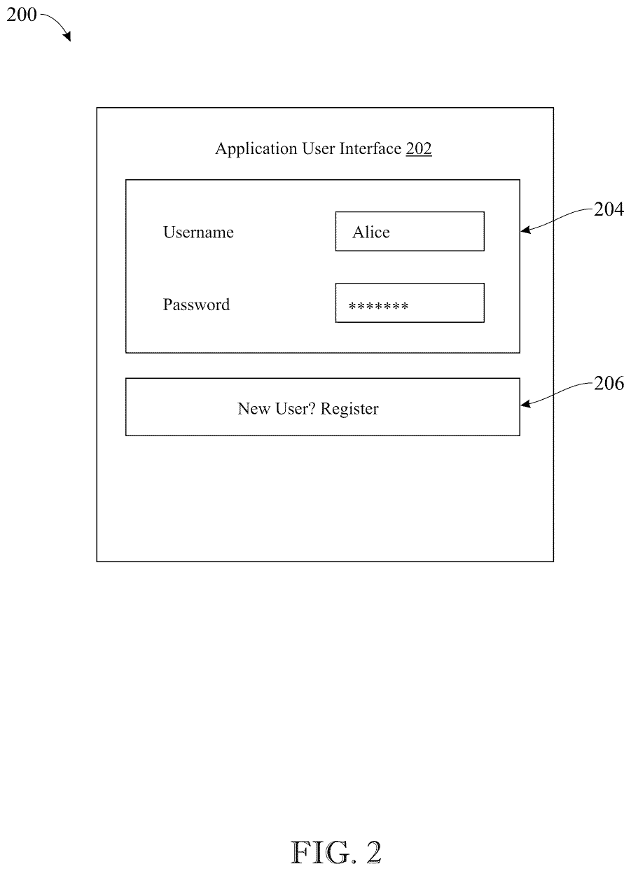

FIG. 2 shows an example representation 200 of a graphical user interface associated with a digital platform, in accordance with embodiments of the present disclosure.

Referring to FIG. 2, the example representation 200 shows a user interface 202 of a software application (e.g., digital platform 116-1) that is installed and/or running on a user device (e.g., 102) associated with a user. The user may be presented with options to either login on the digital platform 116-1 using credentials 204. In some embodiments, the user may login using biometric authentication such as, but not limited to, fingerprint or facial recognition. This provides an added layer of security to ensure that only authorized users can access the information within the digital platform 116-1. The user may then select the appropriate option using touch if a display of the user device 102 is a touchscreen, or by using pointing-and-clicking with a mouse or stylus, or any other suitable method depending on the user device 102 and the display.

In some embodiments, the user may register 206 themselves with a connection engine (e.g., 106) via the digital platform 116-1. In case the user is already registered with the connection engine 106 and has an existing account, the user may opt for logging in by entering user credentials 204 such as username and password or using biometric authentication. In some embodiments, the connection engine 106 may store the user credentials associated with the user for the digital platform 116-1.

In some embodiments, the user may modify their user credentials or information such as username, login identifier, password, etc. associated with the digital platform 116-1. The username 204 may be an identifier for the user in the digital platform 116-1. In some embodiments, the username 204 may be in an alphanumeric format. In some embodiments, the username 204 may be an e-mail address of the user.

In some embodiments, the user may login to the digital platform 116-1 using credentials. The connection engine 106 may perform authentication of the user, for example, with multiple intermediary nodes or software modules in between. In some embodiments, a database (e.g., 114) may contain information (e.g., credentials) necessary to authenticate the user of the user device 102 and also identify which elements of user profile information should be provided to the connection engine 106 when the user accesses the connection engine 106 via the digital platform 116-1. A person of ordinary skill in the art will understand that the credentials may include a means for generating an authenticated reference to a single account identifier. For example, the credentials may include, but not be limited to, a user generated username and password, a mobile phone number, a personal identification number (PIN), and a biometric signature that may be associated with the same profile data of the user for accessing the digital platform 116-1 and the connection engine 106.

In some embodiments, the connection engine 106 may authenticate the user of the user device 102 seeking access to the digital platform 116-1. In such embodiments, the connection engine 106 may request login information via the user interface 202 from the user, such as credentials for the digital platform 116-1. If the user is successfully authenticated, the connection engine 106 may route the user device 102 to the digital platform 116-1 for performing a desired service for the user.

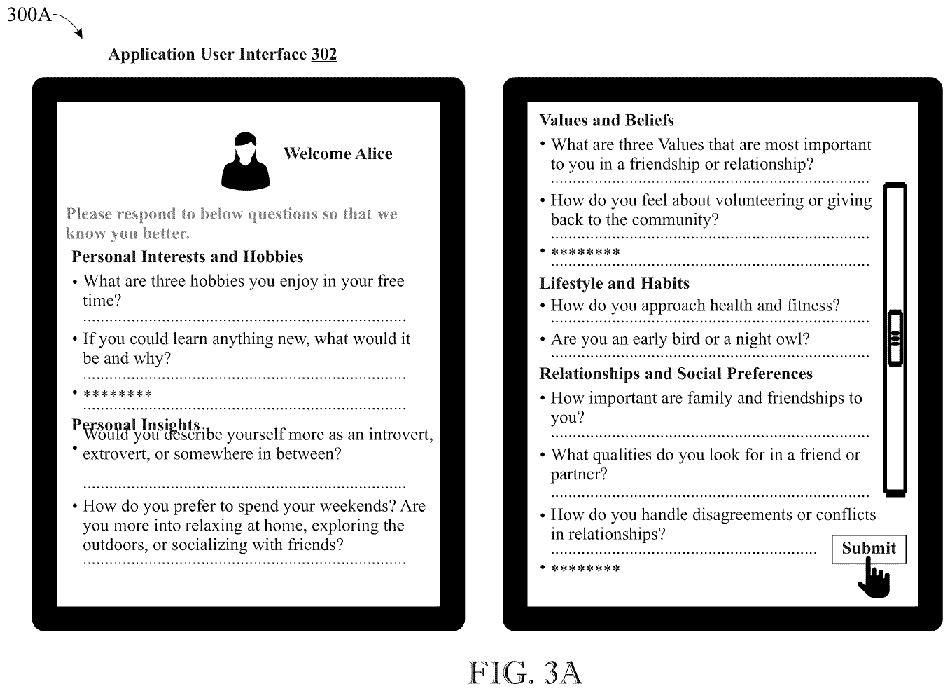

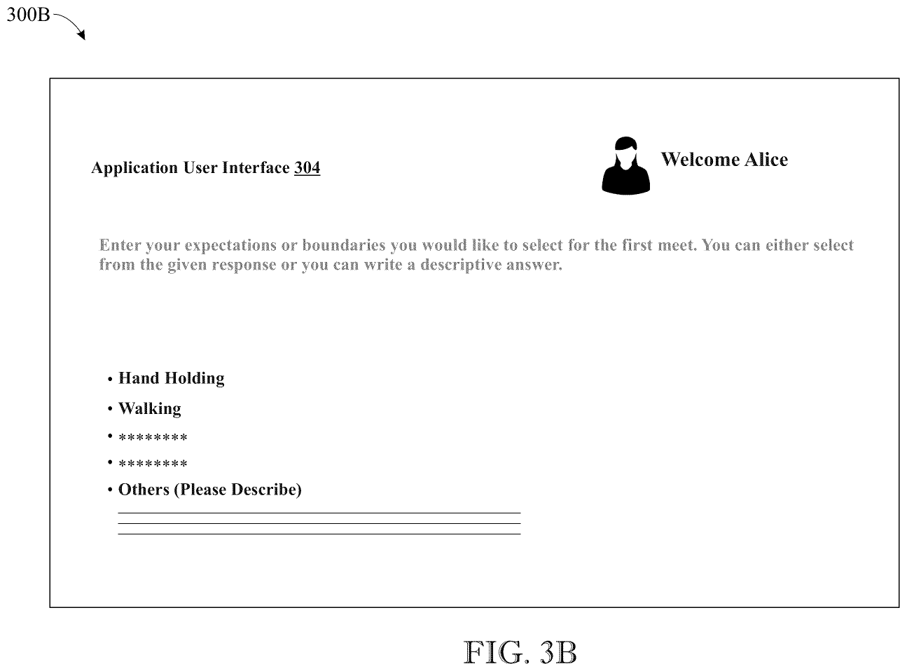

FIG. 3A shows an example representation 300A of a graphical user interface associated with a digital platform for entering profile information, in accordance with some embodiments of the present disclosure.

Referring to FIG. 3A, the example representation 300A shows a user interface 302 associated with a digital platform (e.g., 116-1) to collect profile information from a user once the user registers at the digital platform 116-1. For example, a connection engine (e.g., 106), based on basic demographic information associated with the user, configure a set of questions for the user to respond such as personal interests and hobbies. The connection engine 106 may also seek insights into the user's personality, including whether they see themselves as introvert or extrovert, or their preferences for spending weekends. In some example scenarios, the connection engine 106 may be focused on understanding values and beliefs of the user, for example, what the user values in a friendship or relationship and their thoughts on community involvement. The connection engine 106 may collect information about lifestyle habits, including health and fitness approaches. The connection engine 106 may also collect information about social preferences, like the importance of family and friendships, the qualities they seeks in a friend or partner, and how they handle disagreements.

The profile information may be used by the connection engine 106 for compatibility assessments and consent verification. Based on the analysis, the connection engine 106 may identify suitable matches based on shared values, interests, lifestyles, and more importantly, similar consent. Once the user may have finished answering the questions, the user may select the “Submit” icon to submit their responses. Therefore, the user interface 302 may allow the connection engine 106 to create matches that are compatible and respectful of each other's preferences and consent.

FIG. 3B shows an example representation 300B of a graphical user interface associated with a digital platform for setting one or more social parameters, in accordance with some embodiments of the present disclosure.

Referring to FIG. 3B, the example representation 300B shows a user interface 304 associated with the digital platform 116-1 for gathering one or more social parameters, specifically around expectations or boundaries for a first meeting between users of the digital platform 116-1.

The user interface 304 may prompt the user to enter their expectations or boundaries for the first meeting with another user. The user may be given several options to select from, which likely represent activities or interaction levels they may be comfortable with during a first meeting. These include hand holding, walking, and so on. In some example embodiments, the user may provide their own description of social parameters or boundaries.

The user interface 304 may facilitate in consent verification process. In some embodiments, the connection engine 106 may use Artificial Intelligence (Al) techniques to ensure that any connections made are with individuals who have similar expectations and comfort levels, particularly concerning physical interactions like hand holding, and social activities like walking.

Therefore, in accordance with embodiments of the present disclosure, the connection engine 106 places the user's preferences and comfort at the forefront, allowing for a tailored experience that aligns with individual expectations and boundaries. By providing options such as hand holding and walking, the digital platform 116-1 emphasizes the importance of consent and mutual agreement in social interactions, which is fundamental for user safety and satisfaction. Further, this explicit approach helps ensure that both users have a clear understanding of what to expect during their first meeting, reducing potential anxiety or misunderstandings. The use of Al techniques to analyze user responses assures intelligent and sensitive pairing of individuals, potentially leading to more meaningful and compatible connections. Furthermore, careful consideration of user boundaries likely increases trust in the digital platform 116-1, as users can feel that their personal limits are respected. The information gathered can streamline the matchmaking process, as and can quickly facilitate to identify and suggest matches based on aligned interests and consent, saving users' time and effort. Additionally, by allowing users to set their own pace and level of physical interaction, the digital platform 116-1 supports mental and emotional health, particularly for individuals who may be seeking companionship after a significant life change.

It may be appreciated that the exemplary representations (300A, 300B) may be modular and flexible to accommodate any kind of changes in the digital platform within the scope of the present disclosure.

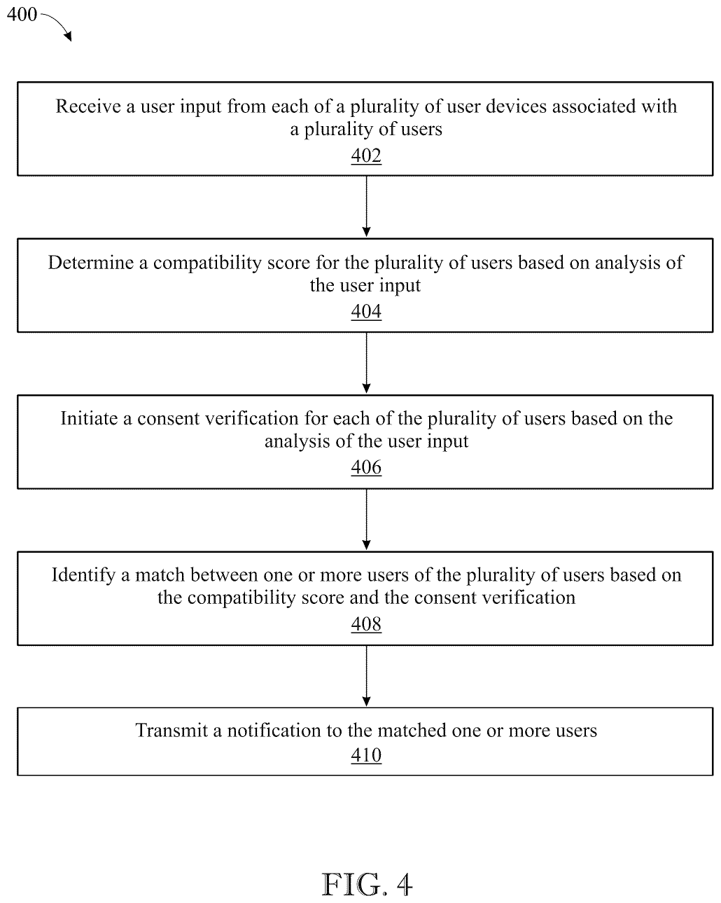

FIG. 4 shows a flow chart of an example method 400 for providing a connection matching application, in accordance with embodiments of the disclosure. FIG. 4 is explained in conjunction with elements from FIG. 1. The steps from 402 to 410 may be implemented by any computing system, such as by the connection engine 106 of FIG. 1.

Referring to FIG. 4, at block 402, a user input from each of a plurality of user devices (e.g., 102) associated with a plurality of users of a digital platform (e.g., 116-1) may be received, for example, by a connection engine (e.g., 106). The user input may include profile information associated with the plurality of users. The profile information collected may include a wide range of data types, from basic textual information to more complex data like behavioural analytics or preference patterns derived from user interactions within the digital platform 116-1. The connection engine 106 may allow users to update their profile information continually, reflecting changes in their preferences or life circumstances, which may be processed by the connection engine 106 in real-time or in batch updates. In some embodiments, the profile information may include, but not limited to, demographic information such as age, gender, location; interests and hobbies such as activities, cultural interests, skills, talents; personal values and beliefs such as religious and spiritual beliefs, political views, ethical standpoints; personality traits; lifestyle preferences; life goals and achievements; social and relationship goals such as type of relationship sought, family plans, friendship dynamics; professional information such as occupation and work habits, educational background, career ambitions; compatibility indicators such as past relationship reflections, desired quality in others, deal-breakers; and safety and privacy preferences such as data sharing comfort level, anonymity preferences, and contact permissions.

In some embodiments, the profile information may also include information related to consent and boundaries such as physical boundaries, emotional boundaries, and communication preferences. The physical boundaries may refer to preferences regarding physical contact, personal space, and public versus private interactions. The emotional boundaries may refer to how quickly the users may prefer to share personal thoughts and feelings. Further, the communication preferences may refer to desired frequency and modes of communication such as, messaging, phone calls, or in-person meetings.

Referring to FIG. 4, at block 404, a compatibility score for the plurality of users may be determined by the connection engine 106. The compatibility score may be determined based on analysis of the profile information of each of the plurality of users. The compatibility score may be a numerical or categorical value calculated by the connection engine 106 to represent the potential for a successful connection between users. In some embodiments, profile information and interaction data may be analyzed to determine the compatibility score. For example, detailed analysis of the users' profile information may be performed by the connection engine 106. The connection engine 106 may also consider interaction data, such as the frequency and type of engagement users have with various features of the digital platform 116-1 or with other user profiles. The connection engine 106 may use any one or a combination of, algorithmic matching, predictive analytics, and weighted factors to determine the compatibility score. In some embodiments, the digital platform 116-1 may display compatibility scores as numerical values, percentages, or star ratings, descriptors, color codes, icons, or the like.

At block 406, a consent verification for one or more social parameters of each of the plurality of users may be initiated. The consent verification may be based on the analysis of the profile information. The connection engine 106 may analyze the profile information to identify each user's stated preferences and boundaries regarding social interactions such as, but not limited to, comfort with physical touch, willingness to engage in certain activities, communication styles, or privacy settings. Based on these identified parameters, the connection engine 106 may generate specific prompts or questions that are presented to the users, asking them to confirm or set their consent for these interactions. For example, if a user has indicated an interest in hand-holding, the connection engine 106 may ask them to confirm under what circumstances they would be comfortable doing so. Users may provide explicit confirmation of their consent through an interface of the digital platform 116-1 (e.g., 304). In some embodiments, the users may have the ability to update their consent parameters at any time, and the digital platform 116-1 may dynamically manage these changes, ensuring that current user interactions reflect the most up-to-date consent information.

Referring to FIG. 4, at block 408, a match between one or more users may be identified. The matched one or more users may be identified based on the compatibility score and the consent verification. In some embodiments, the match may be identified by setting a threshold for the compatibility scores. Only combinations of users whose scores meet or exceed the threshold may be considered as potential matches. The threshold may be determined by historical data indicating which score levels have resulted in successful interactions. In some other embodiments, the connection engine 106 may rank potential matches based on their compatibility scores. Users may be presented with a list of possible matches, starting with the highest-scoring options. The connection engine 106 incorporates feedback from past matches to refine how compatibility scores are calculated, making the process adaptive and more accurate over time.

At block 410, a notification to the matched one or more users may be transmitted by the connection engine 106. The notification may enable the matched one or more users to securely communicate with each other.

Therefore, in accordance with embodiments of the present disclosure, consent-focused connections, particularly those centered around the specific act of hand-holding, enhance the quality of interactions and relationships formed within the digital platform 116-1. By prioritizing consent, especially in a gesture as intimate and significant as hand-holding, the digital platform 116-1 may foster a more respectful, safe, and meaningful environment for users. It enhances trust and safety, supports emotional and physical well-being, encourages respectful interactions, facilitates meaningful connections, improves user experience and satisfaction, and promotes a culture of consent.

It will be appreciated that the blocks shown in FIG. 4 are merely illustrative. Other suitable blocks may be used for the same, if desired. Moreover, the blocks of the method 400 may be performed in any order and may include additional blocks.

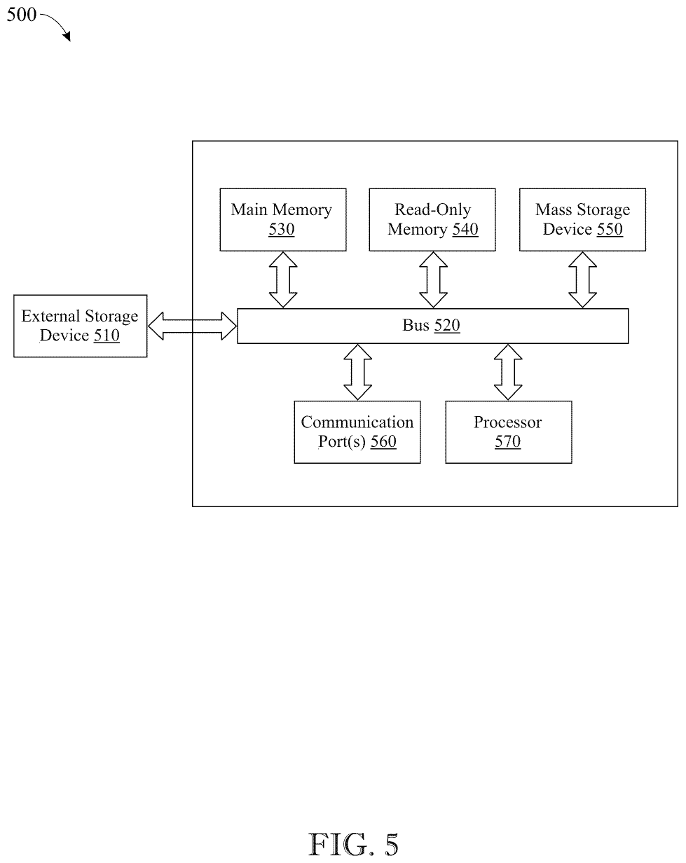

FIG. 5 illustrates an example computer system 500 in which or with which embodiments of the present disclosure may be implemented. In some embodiments, the connection engine 106 of FIG. 1 may be implemented as the computer system 500. Alternatively, or additionally, the plurality of user devices 102 of FIG. 1 may also be implemented as the computer system 500.

As shown in FIG. 5, the computer system 500 may include an external storage device 510, a bus 520, a main memory 530, a read-only memory 540, a mass storage device 550, communication port(s) 560, and a processor 570. A person skilled in the art will appreciate that the computer system 500 may include more than one processor and communication ports. The processor 570 may include various modules associated with embodiments of the present disclosure. The communication port(s) 560 may be chosen depending on a network, such a Local Area Network (LAN), Wide Area Network (WAN), or any network to which the computer system 500 connects. The main memory 530 may be Random-Access Memory (RAM), or any other dynamic storage device commonly known in the art. The read-only memory 540 may be any static storage device(s) e.g., but not limited to, a Programmable Read Only Memory (PROM) chips for storing static information e.g., start-up or BIOS instructions for the processor 570. The mass storage device 550 may be any current or future mass storage solution, which can be used to store information and/or instructions.

The bus 520 communicatively couples the processor 570 with the other memory, storage, and communication blocks. Optionally, operator and administrative interfaces, e.g. a display, keyboard, joystick, and a cursor control device, may also be coupled to the bus 520 to support direct operator interaction with the computer system 500. Other operator and administrative interfaces can be provided through network connections connected through communication port(s) 560. The external storage device 510 may be any kind of external hard-drives, floppy drives, or the like. Components described above are meant only to exemplify various possibilities. In no way should the aforementioned exemplary computer system 500 limit the scope of the present disclosure.

The methods described herein may be performed using the systems described herein. In addition, it is contemplated that the methods described herein may be performed using systems different than the systems described herein. Moreover, the systems described herein may perform the methods described herein and may perform or execute instructions stored in a non-transitory computer-readable storage medium (CRSM). The CRSM may comprise any electronic, magnetic, optical, or other physical storage device that stores executable instructions. The instructions may comprise instructions to cause a processor to perform or control performance of operations of the proposed methods. It is also contemplated that the systems described herein may perform functions or execute instructions other than those described in relation to the methods and CRSM s described herein.

Furthermore, the CRSM s described herein may store instructions corresponding to the methods described herein and may store instructions which may be performed or executed by the systems described herein. Furthermore, it is contemplated that the CRSMs described herein may store instructions different than those corresponding to the methods described herein, and may store instructions which may be performed by systems other than the systems described herein.

The methods, systems, and CRSMs described herein may include the features or perform the functions described herein in association with any one or more of the other methods, systems, and CRSM s described herein.

In some embodiments the method or methods described above may be executed or carried out by a computing system (for example, the computer system 500 of FIG. 5) including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A computer-implemented method, comprising:
receiving, by a connection engine associated with a digital platform, a user input from each of a plurality of user devices associated with a plurality of users of the digital platform, wherein the user input comprises profile information associated with the plurality of users;
determining, by the connection engine, a compatibility score for the plurality of users based on analysis of the profile information of each of the plurality of users;
initiating, by the connection engine, consent verification for one or more social parameters of each of the plurality of users based on the analysis of the profile information;
identifying, by the connection engine, a match between one or more users of the plurality of users based on the compatibility score and the consent verification; and
transmitting, by the connection engine, a notification to the matched one or more users, the notification enabling the matched one or more users to securely communicate with each other.

2. The method of claim 1, wherein the one or more social parameters comprise one or more of: physical contact, meeting settings, or communication preferences parameters.

3. The method of claim 1, wherein the profile information comprises information indicative of personal boundaries of the user.

4. The method of claim 1, further comprising:
updating, by the connection engine, the compatibility score based on feedback from the matched one or more users.

5. The method of claim 1, wherein determining the compatibility score comprises determining the compatibility score via a machine learning algorithm trained on historical data and user interaction outcomes.

6. The method of claim 1, wherein initiating the consent verification comprises validating, by the connection engine, user preferences regarding physical contact that comprises one or more of hand holding, walking, and personal space.

7. The method of claim 1, wherein initiating the consent verification comprises rendering, by the connection engine, a user interface on the user device, which enable the user to provide information corresponding to the one or more social parameters, the information being indicative of social boundaries that the user would like to set for a first meeting with a matched user.

8. A connection engine comprising:
a memory to store instructions; and
a processor in communication with the memory, the processor being configured to execute the instructions to perform or control performance of operations that comprise:
receive a user input from each of a plurality of user devices associated with a plurality of users of a digital platform, wherein the user input comprises profile information associated with the plurality of users;
determine a compatibility score for the plurality of users based on analysis of the profile information of each of the plurality of users;
initiate a consent verification for one or more social parameters of each of the plurality of users based on the analysis of the profile information;
identify a match between one or more users of the plurality of users based on the compatibility score and the consent verification; and
transmit a notification to the matched one or more users, the notification enabling the matched one or more users to securely communicate with each other.

9. The connection engine of claim 8, wherein the one or more social parameters comprise one or more of: physical contact, meeting settings, or communication preferences parameters.

10. The connection engine of claim 8, wherein the profile information comprises information indicative of personal boundaries of the user.

11. The connection engine of claim 8, wherein the operations further comprise an operation to update the compatibility score based on feedback from the matched one or more users.

12. The connection engine of claim 8, wherein the operation to determine the compatibility score comprises an operation to determine the compatibility score via a machine learning algorithm trained on historical data and user interaction outcomes.

13. The connection engine of claim 8, wherein the operation to initiate the consent verification comprises an operation to validate user preferences regarding physical contact that comprises one or more of hand holding, walking, and personal space.

14. The connection engine of claim 8, wherein the operation to initiate the consent verification comprises an operation to render a user interface on the user device, which enables the user to provide information corresponding to the one or more social parameters, the information being indicative of social boundaries that the user would like to set for a first meeting with a matched user.

15. A non-transitory computer-readable storage medium comprising instructions executable by a processor, the instructions to cause the processor to perform or control performance of operations that comprise:
receive a user input from each of a plurality of user devices associated with a plurality of users of a digital platform, wherein the user input comprises profile information associated with the plurality of users;
determine a compatibility score for the plurality of users based on analysis of the profile information of each of the plurality of users;
initiate a consent verification for one or more social parameters of each of the plurality of users based on the analysis of the profile information, wherein the one or more social parameters are associated with physical contact between users during a first meeting;
identify a match between one or more users of the plurality of users based on the compatibility score and the consent verification; and
transmit a notification to the matched one or more users, the notification enabling the matched one or more users to securely communicate with each other

16. The non-transitory computer-readable storage medium of claim 15, wherein the one or more social parameters comprise one or more of: physical contact, meeting settings, or communication preferences parameters.

17. The non-transitory computer-readable storage medium of claim 15, wherein the profile information comprises information indicative of personal boundaries of the user.

18. The non-transitory computer-readable storage medium of claim 15, wherein the operation to determine the compatibility score comprises an operation to determine the compatibility score via a machine learning algorithm trained on historical data and user interaction outcomes.

19. The non-transitory computer-readable storage medium of claim 15, wherein the operation to initiate the consent verification comprises an operation to validate user preferences regarding physical contact that comprises one or more of hand holding, walking, and personal space.

20. The non-transitory computer-readable storage medium of claim 15, wherein the operation to initiate the consent verification comprises an operation to render a user interface on the user device, which enables the user to provide information corresponding to the one or more social parameters, the information being indicative of social boundaries that the user would like to set for a first meeting with a matched user.
